(19) United States
(12) Patent Application Publication
(10) Pub. No.: US 2019/0216069 A1
(43) Pub. Date: Jul. 18, 2019

(54) ERGONOMIC SPINCAST REEL

(71) Applicant: Pure Fishing, Inc., Spirit Lake, IA (US)

(72) Inventors: Mark Talwin, Lexington, SC (US); Joaquim da Rosa, Lexington, SC (US)

(21) Appl. No.: 16/099,216

(22) PCT Filed: May 5, 2017
(86) PCT No.: PCT/US2017/031199

§ 371 Date: Nov. 6, 2018

Related U.S. Application Data
(60) Provisional application No. 62/333,096, filed on May 6, 2016.

(51) Int. Cl. A01K 89/01

(52) U.S. Cl. CPC A01K 89/0102

(57) ABSTRACT

The spincast reel of the invention provides a thumb button system of extended length and shorter displacement travel for engagement and disengagement that enable anglers having small hands, lower grip strength and/or lower dexterity. Such features provide new tools to bring the sport of fishing to more potential anglers. In particular, the extended and lowered thumb portion of the reel optionally combined with a rod handle portion of greater elevation at the reel seat allows the user to use more of a downward motion to engage the casting mechanism of the reel rather than the forward rotational movement of prior spincast reels. The thumb button system is especially well suited for young anglers.

### CROSS-REFERENCES TO RELATED APPLICATIONS

This application claims priority of and the benefit of U.S. Provisional Application No. 62/333,096, entitled “ERGONOMIC SPINCAST REEL,” filed May 6, 2016, the full disclosure of which is incorporated herein by reference for all purposes.

### FIELD OF THE INVENTION

The invention relates to closed face, spincast reels that have features to facilitate use by anglers with smaller hands, lower grip strength and/or lower dexterity.

### BACKGROUND OF THE INVENTION

Spincast reels have been around for many years and are generally viewed as the easiest to use for a beginning angler. A single thumb-actuated button operates to engage and hold the retained fishing line during a retrieval and in preparation for a cast. Releasing the thumb button disengages the retaining mechanisms and allows the fishing line to unspool and allow the lure to be cast to a distance where it falls into the water and retrieved.

Typically, the size, shape and position of the rod handle, reel seat, and reel are based on a standard model for an adult angler. Models for younger anglers are merely scaled down, smaller versions of the basic reel design based on a reel dimensioned for use by an adult of typical hand size. U.S. Pat. No. 6,000,652 describes a spincast reel having a thumb button covered by a resilient material that is designed to more closely fit an angler's thumb. The disclosure of this patent is hereby incorporated by reference.

Little attention has been paid to the needs of anglers having characteristics and needs that are different than a typical adult. Notably, some anglers may not have well developed musculature or dexterity that allows use of a conventional spincast reel. Other anglers may not have thumbs of a typical length or may not desire to exert a conventional level of force with their thumb on a conventional spincast reel.

### SUMMARY OF THE INVENTION

It is an object of the invention to provide a spincast fishing reel that is ergonomically designed to be comfortably used by anglers of all ages.

It is further an object of the invention to provide a spincast reel that can be comfortably used by anglers having smaller hands, reduced grip strength, and/or compromised grip strength.

It is especially an object of thee invention to provide a fishing reel and rod system that is well suited for use by young anglers.

In accordance with these and other objects of the invention that will become apparent from the description herein, the spincast reel of the invention exhibits a thumb button which includes an extended portion towards the rear that allows the user to utilize a primarily downward motion to engage the casting mechanism of the reel. Optionally, the fishing rod to which the spincast reel is secured incorporates a raised, rear handle section that allows the centerline of the reel portion to be lowered even further and thereby reduce the vertical distance between the handle portion and actuating thumb button.

The spincast reel and rod handle changes in the combo kit of the invention provide a system that presents a thumb actuation button that is easier for young anglers, those with lower grip strength or anglers who desire a system that is more fitted to their hand and characteristics than conventional reels.

### BRIEF DESCRIPTION OF THE DRAWINGS

FIG. 1 is a sectional side view of a reel and rod handle section according to the invention.

### DETAILED DESCRIPTION OF THE INVENTION

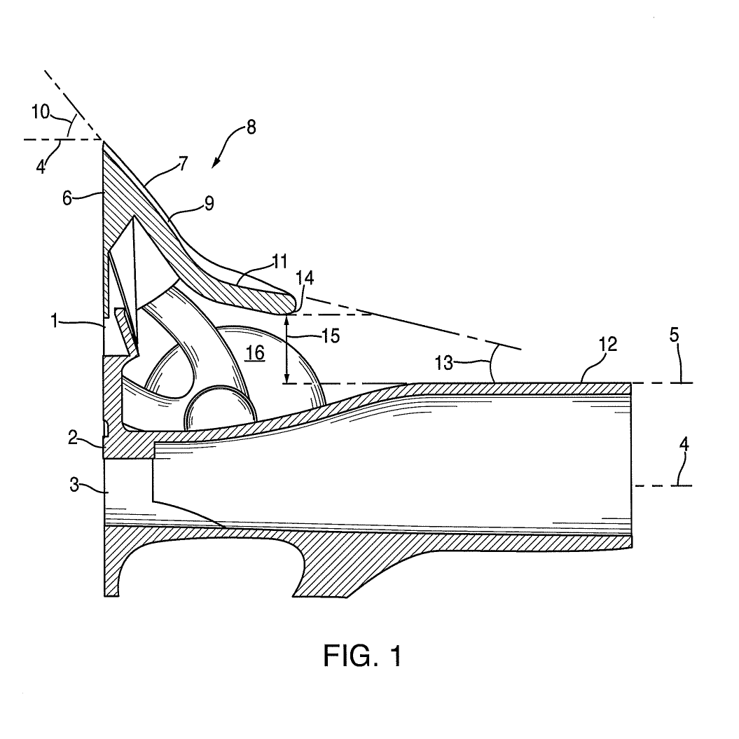

As shown in FIG. 1, spincast reel 1 is seated in reel seat 2 of handle 3 that extends generally along rod axis 4. An upper surface 12 of handle 3 extends axially in an axis 5 that is substantially parallel to rod axis 4. Crank handle 16 is shown in a right-handed orientation.

Thumb button 6 is positioned at the rear 8 of spincast reel 1. Thumb button 6 includes an elongated contact surface 7 with an upper portion 9 and a lower portion 11. Upper portion 9 of the contact surface 7 extends in a generally down-and-back direction toward the handle 3. In an example embodiment, the upper portion 9 may slope at an angle 10 that is generally within the range of 45-60° from rod axis 4. The lower portion 11 of elongated contact surface 7 extends rearward in a direction toward the upper surface 12 of handle 3. As shown in FIG. 1, the lower portion 11 of the contact surface 7 also extends at an angle 13 relative to the rod axis 4. However, the angle 13 of the lower portion 11 is preferably less than angle 10 of the upper portion 9. In an example embodiment, the angle 13 relative to rod axis 4 and upper surface 12 is generally less than 30°. Preferably, the angle 13 is within the range of 5-25°, and even more preferably is within the range of 5-20°.

As will be understood, the specific length of upper portion 9 can be made smaller or longer. A smaller length for upper portion 9 would increase the angle 13, thereby adjusting the orientation of the contact surface 7 relative to the angler's thumb. Consequently, a longer length for upper portion 9 would decrease the angle 13, to a similar but opposite effect. Indirectly, modification of the length of upper portion 9 allows for adjustments to accommodate different hand sizes, grip strengths and thumb lengths.

Another measure of ease of use is the travel distance required to actuate the reel components that engage and disengage the line for retrieving and casting, respectively. As shown in FIG. 1, the rear edge 14 of lower portion 11 of thumb button 6 is spaced a distance 15 from the plane formed by the upper surface 12 of handle 3. A small distance 15 results in less possible travel of the lower portion 11 of the thumb button 6. Less travel results in easier actuation of the thumb button 6. The shallowness of angle 13, which is relatively flat, results in an angle of lower portion 11 that is more comfortable to use for anglers having small hands, reduced grip strength, relatively short thumb length, or anglers with compromised strength or dexterity.

In an example embodiment, distance 15 is less than 20 mm, and is preferably within the range of 5-17 mm, and more preferably within the range of 7-12 mm. It will be understood that the lower limit on travel distance is bounded only by the physical travel distance that is required to actuate the particular casting components between engaged and disengaged positions with the fishing line held by reel 1.

What is claimed is:

1. A spincast combo that comprises:
(a) an axially extended fishing rod including:
a handle at a rear end of the fishing rod, said handle having a reel seat, and
a plurality of fishing line guides distributed from a mid-position to a forward position of said fishing rod; and
(b) a spincast reel having:
a reel foot dimensioned to be secured in the reel seat of the fishing rod handle, and
an actuating thumb button having an upper portion oriented at a first angle with respect to a longitudinal axis of the handle, and a lower portion extending from the upper portion, wherein said lower portion is oriented at a second angle with respect to the longitudinal axis of the handle, and wherein the first angle is larger than the second angle.

2. The spincast combo of claim 1, wherein the second angle is less than about 30 degrees.

3. The spincast combo of claim 1, wherein the second angle is between about 5 degrees and 25 degrees.

4. The spincast combo of claim 3, wherein the second angle is between about 5 degrees and 20 degrees.

5. The spincast combo of claim 1, wherein the first angle is between about 45 degrees and 60 degrees.

6. The spincast combo of claim 1 wherein:
the handle has an upper surface extending in a plane above the reel seat;
the lower portion of the actuating thumb button has a rear edge at a distal end of the lower portion, and
in an undepressed state, the rear edge of the lower portion is spaced from the plane of the upper surface of the handle.

7. The spincast combo of claim 6 wherein the distance between the rear edge of the lower portion of the actuating thumb button is less than 20-mm from the plane of the upper surface.

8. The spincast combo of claim 6 wherein the distance between the rear edge of the lower portion of the actuating thumb button is between about 5-mm and 17-mm from the plane of the upper surface.

9. The spincast combo of claim 6 wherein the distance between the rear edge of the lower portion of the actuating thumb button is between about 7-mm and 12-mm from the plane of the upper surface.

10. The spincast combo of claim 6 wherein depression of the lower portion of the actuating thumb button actuates casting components within the spincast reel to allow unspooling of fishing line therefrom.

11. A spincast reel comprising:
a reel foot dimensioned to be secured in a reel seat of a fishing rod handle, and
an actuating thumb button including:
an upper portion oriented at a first angle with respect to a longitudinal axis of the handle, and
a lower portion extending from the upper portion, wherein said lower portion is oriented at a second angle with respect to the longitudinal axis of the handle, and wherein the first angle is larger than the second angle.

12. The spincast reel of claim 11, wherein the second angle is less than about 30 degrees.

13. The spincast reel of claim 11, wherein the second angle is between about 5 degrees and 25 degrees.

14. The spincast reel of claim 13, wherein the second angle is between about 5 degrees and 20 degrees.

15. The spincast reel of claim 11, wherein the first angle is between about 45 degrees and 60 degrees.

16. The spincast reel of claim 11 wherein:
the handle has an upper surface extending in a plane above the reel seat;
the lower portion of the actuating thumb button has a rear edge at a distal end of the lower portion, and
in an undepressed state, the rear edge of the lower portion is spaced from a plane in which an upper surface of the handle extends.

17. The spincast reel of claim 16 wherein the distance between the rear edge of the lower portion of the actuating thumb button is less than 20-mm from the plane of the upper surface.

18. The spincast reel of claim 16 wherein the distance between the rear edge of the lower portion of the actuating thumb button is between about 5-mm and 17-mm from the plane of the upper surface.

19. The spincast reel of claim 16 wherein the distance between the rear edge of the lower portion of the actuating thumb button is between about 7-mm and 12-mm from the plane of the upper surface.

20. The spincast reel of claim 16 wherein depression of the lower portion of the actuating thumb button actuates casting components within the spincast reel to allow unspooling of fishing line therefrom.
